(19) United States
(12) Patent Application Publication
(10) Pub. No.: US 2008/0318098 A1
(43) Pub. Date: Dec. 25, 2008

(54) Fuel Cell System and Driving Method of Fuel Cell System

(75) Inventor: Kenji Matsunaga, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 11/884,441

(22) PCT Filed: Feb. 1, 2006
(86) PCT No.: PCT/JP2006/302111

§ 371 Date: Aug. 16, 2007

(30) Foreign Application Priority Data
Feb. 25, 2005 (JP) 2005-050320

(51) Int. Cl. H01M 8/04

(52) U.S. Cl. 429/25; 429/14

(57) ABSTRACT

A fuel cell system 10 includes fuel cells 22, a hydrogen supply conduit 60 to supply a hydrogen-containing fuel gas to the fuel cells 22, a first pressure sensor 52 that detects an internal pressure of the hydrogen supply conduit 60, and a shutoff valve 61 that is closed to disconnect the hydrogen supply conduit 60. The fuel cell system 10 further has a supply stop controller that closes the shutoff valve 61 when the internal pressure of the hydrogen supply conduit 60 detected by the first pressure sensor 52 exceeds a preset first reference level.

### TECHNICAL FIELD

The present invention relates to a fuel cell system including fuel cells and a driving method of the fuel cell system.

### BACKGROUND ART

The supply of a hydrogen-containing fuel gas to anodes is required for power generation of fuel cells. Various safety measures are conventionally adopted in a supply system of the fuel gas. Especially in a system of using a high-pressure hydrogen-containing gas supply source (for example, a hydrogen tank) and supplying a high-pressure fuel gas to fuel cells, an effective measure is critical to adequately deal with failed pressure regulation of the fuel gas supplied into the fuel cells. The supply of an overpressure fuel gas to the fuel cells may damage the fuel cells. One possible measure uses a relief valve that is located in a supply flow path for supplying hydrogen gas to fuel cells and is opened at a preset pressure level. The relief valve is opened to release the hydrogen gas to the outside of the supply flow path when the pressure of the hydrogen gas exceeds the preset pressure level.

In the structure of using the relief valve to release the hydrogen gas to the outside, a hydrogen exhaust system including the relief valve is to be designed for minimizing the concentration of inflammable hydrogen released outside. The length of a flow path pipe connecting with the relief valve, the layout of the relief valve and the flow path pipe, and the direction of an exhaust outlet for releasing the hydrogen gas to the outside should be specified to accelerate the diffusion of the hydrogen gas released to the outside. In application of the fuel cell system as a driving power source of a vehicle or another moving body, there is a space limitation for the fuel cell system. This space limitation restricts the design of the piping involved in release of the hydrogen gas.

### DISCLOSURE OF THE INVENTION

For solving the problem of the prior art described above, there is a need of restricting or preventing an excess increase in pressure of a fuel gas supplied to fuel cells without imposing a design restriction in a fuel cell system.

In order to satisfy at least part of the above and the other related demands, one aspect of the present invention is directed to a fuel cell system including fuel cells. The fuel cell system of the invention has: a hydrogen supply flow path that supplies a hydrogen-containing fuel gas to the fuel cells; a first pressure sensor that detects an internal pressure of the hydrogen supply flow path; a shutoff valve that is closed to disconnect the hydrogen supply flow path; and a supply stop controller that closes the shutoff valve, when the internal pressure of the hydrogen supply flow path detected by the first pressure sensor exceeds a preset first reference level.

The fuel cell system of the invention closes the shutoff valve in response to an increase in internal pressure of the hydrogen supply flow path over the first reference level. This arrangement effectively prevents the poor durability of the fuel cells due to application of an overpressure to the fuel cells. There is no design restriction imposed in the fuel cell system for restricting or preventing an excess increase in pressure of the fuel gas.

The technique of the invention is not restricted to the fuel cell system but is actualized by diversity of other applications, for example, a driving method of the fuel cell system and a moving body equipped with the fuel cell system of the invention as a driving power source.

### BRIEF DESCRIPTION OF THE DRAWINGS

FIG. 1 is a block diagram schematically illustrating the structure of a fuel cell system in one embodiment of the invention;

FIG. 2 is a block diagram schematically illustrating the configuration of an electric vehicle; and

FIG. 3 is a flowchart showing a hydrogen overpressure monitoring routine.

### BEST MODES OF CARRYING OUT THE INVENTION

One mode of carrying out the invention is described below as a preferred embodiment with reference to the accompanied drawings.

### A. General System Structure

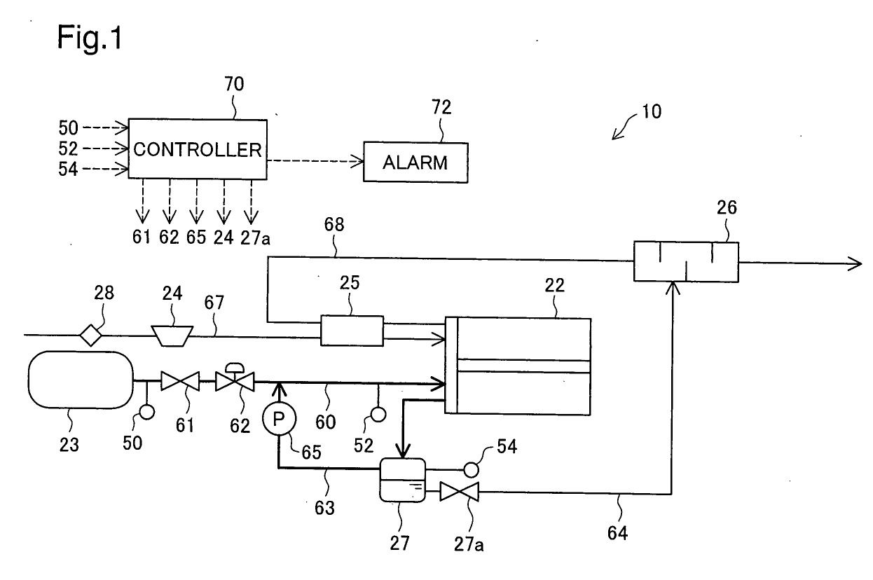

FIG. 1 is a block diagram schematically illustrating the structure of a part involved in power generation of fuel cells in a fuel cell system 10 in one embodiment of the invention. The fuel cell system 10 of the embodiment is mounted on a vehicle and is used as a driving power source for the vehicle. The fuel cell system 10 includes fuel cells 22, a hydrogen tank 23 for storing hydrogen to be supplied to the fuel cells 22, and an air compressor 24 for feeding the compressed air to the fuel cells 22. The fuel cells 22 may be any type of fuel cells and are polymer electrolyte fuel cells in this embodiment. The fuel cells 22 are constructed to have a stack structure of multiple unit cells.

The hydrogen tank 23 may be a hydrogen cylinder for storing high-pressure hydrogen or may include a hydrogen storage alloy to absorb hydrogen therein for storage. The hydrogen gas stored in the hydrogen tank 23 is discharged to a hydrogen supply conduit 60 connecting with the hydrogen tank 23, is regulated (reduced) to a preset pressure level by a pressure regulator valve 62, and is supplied as a fuel gas to anodes of respective unit cells in the fuel cell stack 22. An anode off gas discharged from the anodes of the fuel cells 22 is led through an anode exhaust conduit 63 and is flowed into the hydrogen supply conduit 60. The remaining hydrogen contained in the anode off gas is circulated through a flow path that is formed by a portion of the hydrogen supply conduit 60, the anode exhaust conduit 63, and inner flow paths of the fuel cells 22 (hereafter referred to as “circulation flow path”) and is supplied again for the electrochemical reaction. The amount of hydrogen corresponding to the consumption by the electrochemical reaction is supplemented from the hydrogen tank 23 to the circulation flow path via the pressure regulator valve 62. The anode exhaust conduit 63 is equipped with a hydrogen pump 65 for circulation of the anode off gas through the circulation flow path.

A shutoff valve 61 is provided in the upstream of the pressure regulator valve 62 in the hydrogen supply conduit 60. The shutoff valve 61 is closed in the stop state of power generation by the fuel cells 22 to cut off the supply of hydrogen gas from the hydrogen tank 23 to the fuel cells 22. The control of this embodiment also closes the shutoff valve 61 in response to detection of an excess increase in pressure of the fuel gas supplied to the fuel cells 22. The control based on the fuel gas pressure will be described later in detail. The shutoff valve 61 is, for example, a direct-operated shutoff valve or a pilot shutoff valve. The hydrogen supply conduit 60 also has a pressure sensor 50 that is located in the upstream of the shutoff valve 61 to detect the inner pressure of the hydrogen supply conduit 60. Another pressure sensor 52 is provided in the downstream of the pressure regulator valve 62 in the hydrogen supply conduit 60. The anode exhaust conduit 63 is also equipped with a pressure sensor 54.

The anode exhaust conduit 63 has a gas-liquid separator 27. In the progress of the electrochemical reaction, water is produced on the cathodes of the fuel cells 22 and is invaded through electrolyte membranes into the fuel gas supplied to the anodes of the fuel cells 22. The gas-liquid separator 27 condenses the water vapor contained in the anode off gas and removes the condensed water from the anode off gas.

The gas-liquid separator 27 has a valve 27a. In an open position of the valve 27a, the water condensed in the gas-liquid separator 27 is discharged outside through an exhaust gas discharge conduit 64 connecting with the valve 27a. In the open position of the valve 27a, part of the anode off gas flowing through the anode exhaust conduit 63 is discharged outside, together with the condensed water. During operation of the fuel cells 22, not only the condensed water but nitrogen and gaseous components in the air supplied to the cathodes are invaded from the cathodes through the electrolyte membranes into the hydrogen-containing gas flowing through the anodes. In the course of continuous power generation by the fuel cells 22, the hydrogen-containing gas circulating through the circulation flow path accordingly has an increasing concentration of nitrogen and other impurities. In the fuel cell system 10 of this embodiment, the valve 27a is set open at a predetermined timing to discharge outside the part of the hydrogen-containing gas circulating through the circulation flow path and thereby restrict the increase in concentration of the impurities included in the hydrogen-containing gas.

The exhaust gas discharge conduit 64 is connected to a diluter 26, which is a container having a larger sectional area than the sectional area of the exhaust gas discharge conduit 64. The diluter 26 is provided to dilute hydrogen included in the anode off gas with a cathode off gas (described later) prior to discharge of the anode off gas to the outside.

The air compressor 24 compresses the air and supplies the compressed air as an oxidizing gas through an oxidizing gas supply conduit 67 to the cathodes of the fuel cells 22. The air compressor 24 takes in the outside air via an air cleaner 28 and compresses the intake air. A cathode off gas discharged from the cathodes is flowed through a cathode exhaust conduit 68 and is discharged outside. The oxidizing gas supply conduit 67 and the cathode exhaust conduit 68 go through a humidification module 25. In the humidification module 25, a water vapor-permeable membrane parts the oxidizing gas supply conduit 67 from the cathode exhaust conduit 68. The water vapor-containing cathode off gas is used to humidify the compressed air that is to be supplied to the cathodes. The cathode exhaust conduit 68 goes through the diluter 26 before discharge of the cathode off gas to the outside. The anode off gas flowed through the exhaust gas discharge conduit 64 into the diluter 26 is mixed and diluted with the cathode off gas in the diluter 26 and is then discharged outside.

The fuel cell system 10 has a controller 70 that controls the operations of the respective constituents of the fuel cell system 10. The controller 70 is constructed as a microcomputer-based logic circuit. The controller 70 includes a CPU that performs various arithmetic and logic operations according to preset control programs, a ROM which the control programs and control data required for the various arithmetic and logic operations performed by the CPU are stored in advance, a RAM which diversity of data required for the various arithmetic and logic operations performed by the CPU are temporarily written in and read from, and input and output ports for input and output of various signals. The controller 70 inputs detection signals from the pressure sensors 50, 52, and 54 and diversity of other sensors, as well as information relating to a load demand to the fuel cells 22. The controller 70 outputs driving signals to the part involved in power generation of the fuel cells 22, for example, the pressure regulator valve 62, the air compressor 24, the hydrogen pump 65, and the valves 61 and 27a, in the fuel cell system 10.

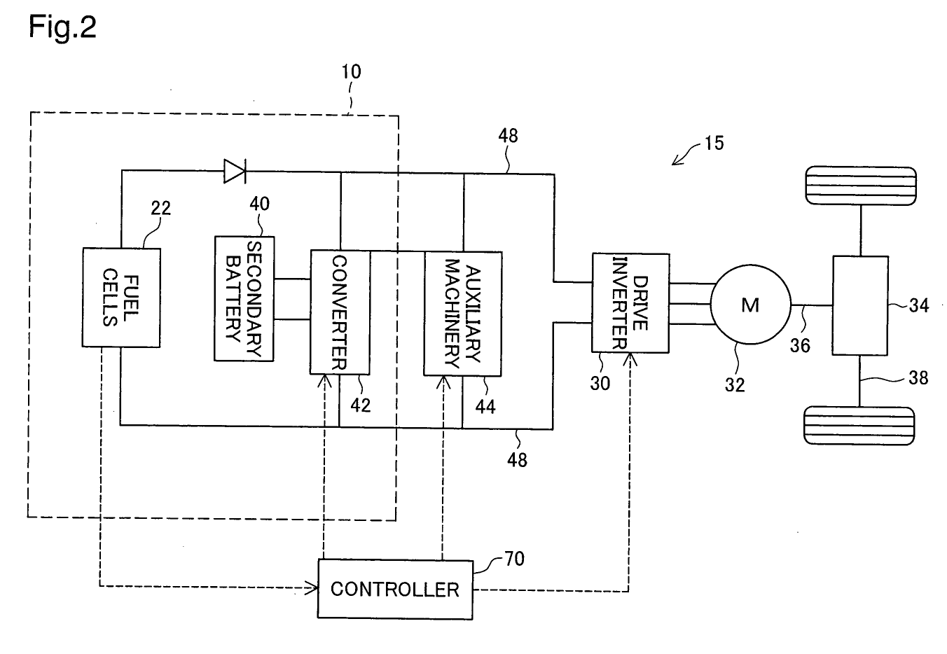

FIG. 2 is a block diagram schematically illustrating the configuration of an electric vehicle 15 equipped with the fuel cell system 10 of the embodiment. As shown in FIG. 2, the fuel cell system 10 mounted as the driving power source of the vehicle includes a secondary battery 40, in addition to the fuel cells 22 as the main body of power generation. FIG. 2 mainly shows the electrical connection involved in power generation of the fuel cells 22. The flow paths of gases supplied to and discharged from the fuel cells 22 are omitted from the illustration of FIG. 2.

The electric vehicle 15 has a drive motor 32 connected with the fuel cell system 10 via a drive inverter 30 and auxiliary machinery 44 as loads receiving the supply of electric power from the fuel cell system 10. These loads are connected to the fuel cell system 10 by wiring 48. Electric power is transmitted between the fuel cell system 10 and the loads via the wiring 48. The secondary battery 40 is connected to the wiring 48 via a DC-DC converter 42. The DC-DC converter 42 and the fuel cells 22 are connected in parallel to the wiring 48.

The secondary battery 40 may be any of various rechargeable batteries, for example, a lead acid storage battery, a nickel-cadmium battery, a nickel-hydrogen battery, or a lithium secondary battery. The secondary battery 40 supplies electric power for driving the respective constituents of the fuel cell system 10 at a start of the fuel cell system 10, while supplying electric power to the respective loads until completion of the warm-up operation of the fuel cell system 10. In the course of power generation by the fuel cells 22 in the stationary state, the secondary battery 40 may supplement an insufficient electric power in response to an increase of the total required loading above a predetermined level.

The DC-DC converter 42 sets a target output voltage and regulates the voltage level of the wiring 48 and the output voltage from the fuel cells 22, so as to control the amount of power generation by the fuel cells 22. The DC-DC converter 42 also functions as a switch for controlling the connection between the secondary battery 40 and the wiring 48. The DC-DC converter 42 cuts off the connection between the secondary battery 40 and the wiring 48 when there is no requirement for charging or discharging the secondary battery 40.

The drive motor 32 as one of the loads is a synchronous motor and has three-phase coils for formation of a rotating magnetic field. The drive motor 32 receives a supply of electric power from the fuel cell system 10 via the drive inverter 30. The drive inverter 30 is a transistor inverter including transistors or switching elements corresponding to the respective phases of the drive motor 32. An output shaft 36 of the drive motor 32 is connected to a vehicle driveshaft 38 via a reduction gear 34.

The auxiliary machinery 44 as another load includes the air compressor 24, the hydrogen pump 65, and other fuel cell-related auxiliary machines required for power generation by the fuel cells 22. Electric power having voltage reduced by a step-down DC-DC converter (not shown) is supplied to valves having lower driving voltages among the auxiliary machinery 44. The auxiliary machinery 44 includes vehicle-related auxiliary machines, for example, an air conditioner of the electric vehicle 15, as well as the fuel cell-related auxiliary machines.

In the structure of the embodiment, the controller 70 is included in the fuel cell system 10. The controller 70 controls the operations of the whole electric vehicle 15 in this embodiment. The controller 70 accordingly outputs driving signals to the drive inverter 30, as well as to the auxiliary machinery 44 and the DC-DC converter 42.

### B. Process of Preventing Excess Increase of Hydrogen Gas Pressure

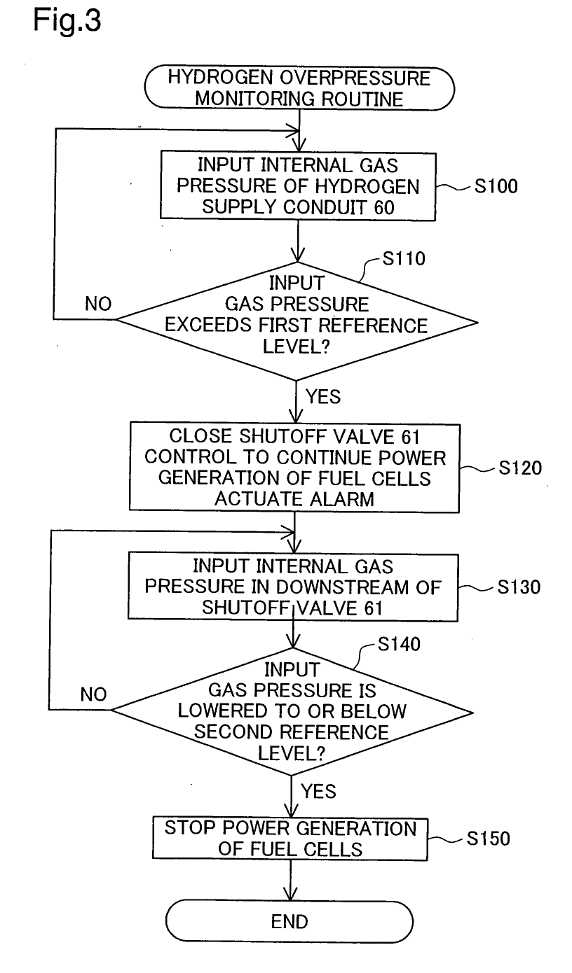

FIG. 3 is a flowchart showing a hydrogen overpressure monitoring routine executed by the controller 70. This routine is performed during operation of the fuel cell system 10. In the hydrogen overpressure monitoring routine, the controller 70 first inputs an internal gas pressure of the hydrogen supply conduit 60 (step S100). In the structure of this embodiment, the controller 70 inputs a detection signal of the pressure sensor 52 provided in the downstream of the pressure regulator valve 62.

The controller 70 subsequently determines whether the internal gas pressure input at step S100 exceeds a preset first reference level (step S110). The first reference level is set in advance as a value exceeding an allowable range for the pressure in the circulation flow path during power generation of the fuel cells 22. When the internal gas pressure input at step S100 does not exceed the first reference level, it is determined that the internal pressure of the circulation flow path is kept in the allowable range. The controller 70 then repeats the processing of steps S100 and S110.

When it is determined at step S110 that the input internal gas pressure exceeds the first reference level, on the other hand, the controller 70 closes the shutoff valve 61, continues power generation of the fuel cells 22 at a predetermined low level of electric current, and actuates a preset alarm (step S120). The controller 70 accordingly works as the supply stop controller that performs control to close the shutoff valve 61 according to the input internal gas pressure, while working as the hydrogen consumption controller that performs control to continue power generation of the fuel cells 22. In continuation of the power generation by the fuel cells 22 at step S120, the shutoff valve 61 is closed to restrict the amount of hydrogen usable for power generation to a limited small amount. The power generation of the fuel cells 22 at the predetermined low level of electric current effectively stabilizes the state of power generation.

When a valve that is closed in response to no supply of electric power is applied to the shutoff valve 61, the supply of electric power to the shutoff valve 61 is cut off to close the shutoff valve 61.

The air compressor 24 is kept driving to continue the supply of the oxidizing gas to the fuel cells 22 and accordingly continue the power generation of the fuel cells 22. In the closed position of the shutoff valve 61 to cut off the supply of hydrogen from the hydrogen tank 23, the fuel cells 22 can utilize only the remaining hydrogen in the circulation flow path. The power generation after the closure of the shutoff valve 61 is for the purpose of consuming the remaining hydrogen in the circulation flow path. The electric power generated by such power generation is thus naturally limited. The electric power generated by the power generation of the fuel cells 22 at step S120 may be supplied to and consumed by a certain load. In the structure of this embodiment, however, the generated electric power is charged into the secondary battery 40. For example, the DC-DC converter 42 shown in FIG. 2 sets a sufficiently high value to the voltage of the wiring 48 to charge the secondary battery 40. The amount of power generation after the closure of the shutoff valve 61 is extremely low. Simple setting of the sufficiently high voltage level enables the secondary battery 40 to be readily charged with the generated electric power, irrespective of the current state of charge in the secondary battery 40. The controller 70 works as the charge controller that controls the DC-DC converter 42 and the relevant part to charge the secondary battery 40 with the electric power generated by the power generation of the fuel cells 22. Since there is only a short power generation time after the closure of the shutoff valve 61, the operation of the hydrogen pump 65 is not required for the power generation of the fuel cells 22 at step S120.

The vehicle of the embodiment has an alarm 72 that informs the user of the hydrogen overpressure and the cutoff of the hydrogen supply (see FIG. 1). At step S120, the controller 70 also actuates the alarm 72. The alarm 72 may be provided in the form of a display located near the driver's seat (for example, an instrument panel) in the electric vehicle 15. An alarm display of a specific form may be lit on the display at step S120. The alarm 72 may otherwise be a preset voice of informing the user of the hydrogen overpressure or a preset alarm sound.

After the processing of step S120, the controller 70 inputs the internal pressure of the circulation flow path in the downstream of the shutoff valve 61 (step S130). In the structure of this embodiment, the controller 70 inputs a detection signal from the pressure sensor 52. A detection signal of the pressure sensor 54 provided in the downstream of the fuel cells 22 may alternatively be input as the internal pressure of the circulation flow path at step S130.

The controller 70 subsequently determines whether the internal gas pressure input at step S130 is lowered to or below a preset second reference level (step S140). The second reference level is set in advance as a reference pressure value proving a sufficiently low level of gas pressure in the circulation flow path. When the internal gas pressure input at step S130 is still higher than the second reference level, it is determined that the internal gas pressure of the circulation flow path has not yet been lowered to the allowable range. The controller 70 accordingly repeats the processing of steps S130 and S140. The fuel cells 22 then continue power generation to keep consuming the remaining hydrogen in the circulation flow path. The internal gas pressure input at step S130 is eventually lowered to or below the second reference level.

When it is determined at step S140 that the internal gas pressure of the circulation flow path is lowered to or below the second reference level, the controller 70 stops the power generation of the fuel cells 22 (step S150) and exits from this hydrogen overpressure monitoring routine. A concrete procedure of stopping the power generation of the fuel cells 22 stops the operations of the fuel cell-related auxiliary machinery including the air compressor 24 and disconnects the fuel cells 22 from the secondary battery 40 receiving the supply of electric power from the fuel cells 22.

In the state where the supply of hydrogen to the fuel cells 22 is cut off in response to detection of hydrogen overpressure in the hydrogen supply conduit 60, the drive motor 32 on the electric vehicle 15 receives a supply of electric power from the secondary battery 40 to keep driving the electric vehicle 15. This allows, for example, an adequate action in the case of an emergency.

As described above, in the electric vehicle 15 equipped with the fuel cell system 10 of the embodiment, the shutoff valve 61 is closed in response to detection of an excess increase of the gas pressure in the hydrogen supply conduit 60 over the first reference level. Such control effectively prevents the poor durability of the fuel cells 22 due to application of an overpressure to the fuel cells 22. This embodiment utilizes the shutoff valve 61 provided in the hydrogen supply conduit 60 to restrict or prevent an excess increase in internal pressure of the hydrogen supply conduit 60. This arrangement neither complicates the configuration of the fuel cell system 10 nor lowers the degree of freedom in design. The use of the shutoff valve 61, which is conventionally used to cut off the flow of the hydrogen gas in the ordinary power generation stop state of the fuel cells 22, does not increase the total number of parts.

Another possible technique of preventing the overpressure in the hydrogen supply conduit 60 uses a relief valve that is provided in the hydrogen supply conduit 60 and is opened at a preset pressure level. In response to an excess increase of the internal pressure, the hydrogen gas is released from the relief valve. In this application, however, for the effective diffusion of the released hydrogen, there is a certain restriction on the degrees of freedom in layout of respective constituents and in piping design of an electric vehicle. This may lead to the undesirably complicated structure of the whole system. The arrangement of this embodiment, on the other hand, simply uses the valve originally provided in the hydrogen supply conduit 60 and does not cause any of such problems. The relief valve connected to the outside may have a failure, for example, due to invasion of a foreign substance and may not exert the sufficient effect of preventing the excess increase in hydrogen pressure. The valve used in this embodiment is located in the hydrogen supply conduit 60 that is not connected to the outside and is thus free from this problem. The arrangement of the embodiment accordingly ensures the high reliability of the mechanism for restricting or preventing the excess increase in internal pressure of the hydrogen supply conduit 60.

When the internal pressure of the hydrogen supply conduit 60 exceeds the first reference level, the fuel cell system 10 of the embodiment continues the power generation of the fuel cells 22 to keep consuming the remaining hydrogen in the circulation flow path after the closure of the shutoff valve 61. The fuel cell system 10 stops the operation of the fuel cells 22 after a sufficient decrease in internal pressure of the circulation flow path. Such control desirably prevents an excess pressure from being applied to the anodes of the fuel cells 22 after the stop of the power generation. The arrangement of the embodiment effectively eliminates a pressure difference between the anodes and the cathodes across the electrolyte membranes in the fuel cells 22 and protects the fuel cells 22 from a potential damage caused by the pressure difference. In the structure of the embodiment, when the air compressor 24 stops working in the stop state of power generation of the fuel cells 22, the flow path in the cathodes of the fuel cells 22 has an approximately atmospheric pressure level.

After the closure of the shutoff valve 61 in response to detection of an overpressure in the hydrogen supply conduit 60, the secondary battery 40 is charged with the electric power generated by the continued power generation of the fuel cells 22. This arrangement has an additional effect of enhancing the overall system efficiency of the whole fuel cell system 10.

The fuel cell system 10 of the embodiment closes the shutoff valve 61 and actuates the alarm 72 in response to detection of an overpressure in the hydrogen supply conduit 60. The user is thus accurately informed of the cause of a system shutdown and is allowed to take an appropriate action. In the structure of this embodiment, the occurrence of a failure is detected based on the pressure in the downstream of the pressure regulator valve 62. There is accordingly a high probability that the pressure regulator valve 62 has some failure.

### C. Modifications

The embodiment discussed above is to be considered in all aspects as illustrative and not restrictive. There may be many modifications, changes, and alterations without departing from the scope or spirit of the main characteristics of the present invention. Some examples of possible modification are given below.

(1) The positions of the valves and the pressure sensors in the hydrogen supply conduit 60 are not restricted to the layout of FIG. 1. For example, the shutoff valve 61 may be located in the downstream of the pressure regulator valve 62, in place of the upstream of the pressure regulator valve 62. The pressure sensor used for input of the internal gas pressure at step S100 in the hydrogen overpressure monitoring routine may be located in the upstream of the shutoff valve 61 or in the downstream of the shutoff valve 61. This is because the pressures detected at different locations in the hydrogen supply conduit 60 are correlated before closure of the shutoff valve 61, regardless of the upstream or downstream position of the shutoff valve 61. As long as the pressure sensor located in the downstream of the pressure regulator valve 62 is used for input of the internal gas pressure at step S130, a failed pressure regulation by the pressure regulator valve 62 is detectable.

(2) The technique of the invention is applicable to a fuel cell system having a different structure from the structure of the embodiment. In the fuel cell system 10 of the embodiment, the hydrogen gas supplied to the fuel cells 22 is circulated through the circulation flow path. One possible modification may adopt a dead-end structure that omits an anode exhaust conduit and does not allow discharge of the anode off gas from fuel cells. This modified structure does not cause circulation of the hydrogen gas but simply supplies the amount of hydrogen corresponding to the consumption by power generation to the fuel cells. The principle of the invention is adopted in this modified structure to restrict or prevent an overpressure due to failed regulation of the amount of hydrogen newly supplied to the fuel cells.

Another possible modification may use a reformer, in place of the hydrogen tank for storage of high-purity hydrogen. The reformer reforms a hydrocarbon fuel to a reformed gas and supplies the reformed gas as a fuel gas to fuel cells. The principle of the invention is adopted in this modified structure to monitor the internal pressure of the fuel gas supplied to the fuel cells and close a shutoff valve provided in a fuel gas flow path in response to an overpressure of the fuel gas in order to cut off the supply of the fuel gas to the fuel cells.

The technique of the invention is applicable to the fuel cell system that is used as a stationary power generation, as well as to the fuel cell system mounted on a moving body as a driving power source.

In any of such modified structures, application of the present invention has the similar effects of preventing an overpressure from being applied to the fuel cells in the event of an excess increase in pressure of the fuel gas supplied to the fuel cells. The control of the invention in any of these modified structures may close the shutoff valve in response to detection of an overpressure in the downstream of a pressure regulator valve that regulates the pressure of the fuel gas supplied to the fuel cells (a pressure regulator valve closest to the fuel cells in a system having multiple pressure regulator valves). This arrangement effectively restricts or prevents an overpressure due to some failure of the pressure regulator valve.

1. A fuel cell system that includes fuel cells as a vehicle driving source and a fuel gas source mounted on an identical vehicle, the fuel cell system comprising:
a hydrogen supply flow path that connects the fuel gas source and the fuel cells to supply a hydrogen-containing fuel gas to the fuel cells;
a first pressure sensor that detects an internal pressure of the hydrogen supply flow path;
a shutoff valve that changes over a connection status of the hydrogen supply flow path between a connecting state and a disconnecting state; and
a supply stop controller that controls the shutoff valve to change over the connection status of the hydrogen supply flow path to the disconnecting state, when the internal pressure of the hydrogen supply flow path detected by the first pressure sensor exceeds a preset first reference level representing an overpressure to the fuel cells.

2. The fuel cell system in accordance with claim 1, the fuel cell system further comprising:
a pressure regulator that is provided in the hydrogen supply flow path to regulate a pressure of the fuel gas supplied to the fuel cells,
wherein the first pressure sensor detects the internal pressure of the hydrogen supply flow path at a position closer to the fuel cells than an installation location of the pressure regulator.

3. The fuel cell system in accordance with claim 1, the fuel cell system further comprising:
a hydrogen consumption controller that performs control to consume remaining hydrogen in the hydrogen supply flow path between the shutoff valve and the fuel cells, after the shutoff valve changes over the connection status of the hydrogen supply flow path to the disconnecting state.

4. The fuel cell system in accordance with claim 3, wherein the first pressure sensor detects the internal pressure of the hydrogen supply flow path at a position closer to the fuel cells than an installation location of the shutoff valve, and
the hydrogen consumption controller stops the control of consuming the remaining hydrogen in the hydrogen supply flow path, when the internal pressure of the hydrogen supply flow path detected by the first pressure sensor is lowered to or below a preset second reference level, which is lower than the first reference level.

5. The fuel cell system in accordance with claim 3, wherein the first pressure sensor detects the internal pressure of the hydrogen supply flow path at a position closer to the fuel gas source than an installation location of the shutoff valve,
the fuel cell system further comprising:
a second pressure sensor that detects the internal pressure of the hydrogen supply flow path at a position closer to the fuel cells than the installation location of the shutoff valve,
the hydrogen consumption controller stopping the control of consuming the remaining hydrogen in the hydrogen supply flow path, when the internal pressure of the hydrogen supply flow path detected by the second pressure sensor is lowered to or below a preset second reference level, which is lower than the first reference level.

6. The fuel cell system in accordance with claim 1, the fuel cell system further comprising:
an alarm that informs a user of an excess increase in internal pressure of the hydrogen supply flow path, when the shutoff valve is closed to change over the connection status of the hydrogen supply flow path to the disconnecting state.

7. A driving method of a fuel cell system that includes fuel cells as a vehicle driving source and a fuel gas source mounted on an identical vehicle, the driving method comprising:
detecting an internal pressure of a hydrogen supply flow path that supplies a hydrogen-containing fuel gas to the fuel cells; and
when the detected internal pressure exceeds a preset reference level, closing a shutoff valve provided in the hydrogen supply flow path to disconnect the hydrogen supply flow path and thereby cut off the supply of the fuel gas to the fuel cells representing an overpressure to the fuel cells.

8. The fuel cell system in accordance with claim 3, wherein the hydrogen consumption controller continues operation of the fuel cells to consume the remaining hydrogen in the hydrogen supply flow path between the shutoff valve and the fuel cells, after the shutoff valve changes over the connection status of the hydrogen supply flow path to the disconnecting state.

9. The fuel cell system in accordance with claim 2, the fuel cell system further comprising:
a hydrogen consumption controller that performs control to consume remaining hydrogen in the hydrogen supply flow path between the shutoff valve and the fuel cells, after the shutoff valve changes over the connection status of the hydrogen supply flow path to the disconnecting state.

10. The fuel cell system in accordance with claim 9, wherein the first pressure sensor detects the internal pressure of the hydrogen supply flow path at a position closer to the fuel cells than an installation location of the shutoff valve, and
the hydrogen consumption controller stops the control of consuming the remaining hydrogen in the hydrogen supply flow path, when the internal pressure of the hydrogen supply flow path detected by the first pressure sensor is lowered to or below a preset second reference level, which is lower than the first reference level.

11. The fuel cell system in accordance with claim 9, wherein the first pressure sensor detects the internal pressure of the hydrogen supply flow path at a position closer to the fuel gas source than an installation location of the shutoff valve,
the fuel cell system further comprising:
a second pressure sensor that detects the internal pressure of the hydrogen supply flow path at a position closer to the fuel cells than the installation location of the shutoff valve,
the hydrogen consumption controller stopping the control of consuming the remaining hydrogen in the hydrogen supply flow path, when the internal pressure of the hydrogen supply flow path detected by the second pressure sensor is lowered to or below a preset second reference level, which is lower than the first reference level.

12. The fuel cell system in accordance with claim 3, wherein the hydrogen consumption controller continues operation of the fuel cells to consume the remaining hydrogen in the hydrogen supply flow path between the shutoff valve and the fuel cells, after the shutoff valve changes over the connection status of the hydrogen supply flow path to the disconnecting state.
